(19) United States
(12) Patent Application Publication
(10) Pub. No.: US 2026/0199718 A1
(43) Pub. Date: Jul. 16, 2026

(54) Fire extinguishing concept in high-bay warehouse

(71) Applicant: AMOVA GmbH, Hilchenbach (DE)

(72) Inventors: Bernd BÜDENBENDER, Siegen (DE); Volker BRÜCK, Mudersbach (DE); Carsten HUPPERTZ, Olpe (DE)

(73) Assignee: AMOVA GmbH, Hilchenbach (DE)

(21) Appl. No.: 19/136,166

(22) PCT Filed: Jan. 11, 2024
(86) PCT No.: PCT/EP2024/050547

§ 371 Date: Jun. 5, 2025

(30) Foreign Application Priority Data
Jan. 24, 2023 (DE) 10 2023 101 670.9

(51) Int. Cl. A62C 3/00; A62C 31/22; A62C 37/36; B66F 9/07

(52) U.S. Cl. CPC A62C 3/002; A62C 31/22; A62C 37/36; B66F 9/07

(57) ABSTRACT

A high-bay storage system for storing and retrieving containers has a plurality of container storage spaces arranged horizontally next to one another and vertically one above another. Storage aisles are arranged between groups of rack compartments and extend parallel to one another. A stacker crane is movable back and forth in the storage aisles. The stacker crane moves the containers vertically and horizontally and into and out of the rack compartments. The stacker crane is connected to a fire extinguishing device. A method for detecting and preferably fighting fires in a high-bay storage system monitors the temperature and/or change in temperature of a container stored within the rack compartment or of the area surrounding the container. If a previously defined threshold value of the temperature and/or the change in temperature is exceeded, the corresponding container is removed from the rack compartment by a stacker crane.

### CROSS-REFERENCE TO RELATED APPLICATION

This application is a national stage application, filed under 35 U.S.C. § 371, of International Patent Application PCT/EP2024/050547, filed on Jan. 11, 2024, which claims the benefit of German Patent Application DE 10 2023 101 670.9, filed on Jan. 24, 2023.

### TECHNICAL FIELD

The invention relates to a high-bay storage system for storing and retrieving containers, with a fire-extinguishing concept used therein, and to a method for fighting fires in such a high-bay storage system.

### BACKGROUND

High-bay storage (HBS) systems are well known from the prior art and are widely used in particular in transhipment facilities of seaports or inland ports. The high-bay storage systems usually have a plurality of rack compartments arranged horizontally next to one another and vertically one above the other, preferably separate rack compartments, and storage aisles which are arranged between groups of rack compartments and extend parallel to one another and in each of which at least one stacker crane is movable back and forth, this stacker crane being designed to move the containers vertically and horizontally and to move them into and out of the rack compartments.

One example of such a high-bay storage system is disclosed in WO 2015/1243482 A1. In this high-bay storage system, standard containers are picked up by a stacker crane at a transfer point within the high-bay storage system and then conveyed by the stacker crane to a previously defined rack compartment and stored in this rack compartment. The containers are grasped suspended from above and laterally inserted into the respective rack compartments by means of a telescopic system such that the longitudinal side of the container is aligned parallel to the storage aisle. This leads to maximum utilisation of the space within the bay warehouse because the storage aisles only need to be designed somewhat wider than the respective front sides of the containers. This special handling and storage of containers, in particular empty containers, also has the result that, with a suitable design of the telescopic systems on the stacker cranes, in each case two adjacently arranged rack compartments on each side, thus a total of four rack compartments (“double deep”), can be accessed from each storage aisle.

Typically, at least one stacker crane is provided in each storage aisle, by means of which each container can be transferred from a defined picking position to the respective rack compartment, and similarly a container can be removed from the rack compartment again and taken to a suitable transfer position, so as to then be picked up directly by an external means of transport or indirectly with the interposition of suitable transfer devices.

The ability of the respective stacker crane to pick up, move and then release a container, as well as the number of stacker cranes within a storage aisle, is the factor that determines the handling capacity of the high-bay storage system, this factor typically being finalised when the high-bay storage system is designed.

In containers for the worldwide transshipment of goods, unfavourable conditions can lead to fire-related events, which can also spread to the areas surrounding the containers. Such fire-related events are frequently connected to improper storage of flammable substances, to the containers heating up because of improper stacking and/or storage of containers in stacking areas in high-bay storage systems, transport vehicles such as ships or like, to the goods stored in the containers not being properly secured, which in particular in the event of high acceleration of the containers can result in the stored goods being damaged or catching fire, to an undesirable electrical discharge in particular in the direct vicinity of flammable goods or the like. Although containers are typically so tightly sealed off from their surroundings that the ingress or escape of liquids is typically not possible and the supply of oxygen to the interior of the container is so heavily restricted that the outbreak of a fire within the container is localised, a fire can nevertheless spread from a container to its surrounding area as a result of heat radiation or, if a container is in direct contact with a neighbouring container, as a result of heat transfer from one outer shell to the next. This endangers the safety of entire sections of storage spaces, transport vehicles or high-bay storage systems and the integrity of all stored and/or transported goods.

In high-bay storage systems, the outbreak of a fire in one or more of the containers stored therein is an event that can have serious consequences for the safety of both the high-bay storage systems and the goods stored therein and also of the personnel working there and the surrounding area. To date, fires in high-bay storage systems, in particular for containers, could only be discovered and fought to an inadequate extent, meaning that relatively large areas of a high-bay storage system or the entire high-bay storage system frequently had to be abandoned or could only be insufficiently exposed to extinguishing agents from the outside to at least contain fires.

### SUMMARY

It is an object of the disclosure to provide a high-bay storage system with a fire-extinguishing concept used and in particular integrated therein, and a method for fighting fires in such a high-bay storage system. This object is solved by a high-bay storage system and by a method for detecting and preferably fighting fires in a high-bay storage system as disclosed herein.

Provision is made of a high-bay storage system for storing and retrieving containers, which has a plurality of rack compartments arranged horizontally next to one another and vertically one above another for containers, and storage aisles which are arranged between groups or levels of rack compartments and extend parallel to one another and in each of which at least one stacker crane is movable back and forth, this stacker crane being designed to move the containers vertically and horizontally and to move them into and out of the rack compartments. Typically, such groups of rack compartments are provided as modules extending over almost the entire length and height of the high-bay storage systems. The rack compartments are preferably provided as separately arranged rack compartments and can thus also be travelled to separately by at least one stacker crane in order to store or retrieve a container. The containers are thus accommodated in the rack compartments individually or at most in pairs (for example two 20-foot containers in a 40-foot rack compartment), and there only needs to be sufficient space above the containers for operating the stacker crane's conveying mechanisms, in particular telescopic systems, with which the containers can be connected suspended and moved perpendicular to the storage aisles into the rack compartments.

Preferably, stacker cranes that are used in the high-bay storage systems are connected to a fire extinguishing device, by means of which the containers picked up by the stacker cranes can be cooled at least from the outside, and preferably the interior of the container can be exposed to extinguishing agent.

At least one stacker crane, by means of which the containers are stored, relocated and retrieved within the high-bay storage system, is connected to a fire extinguishing device. It is preferred if each stacker crane used within the high-bay storage system is connected to a fire extinguishing device. As a result, the fire extinguishing device can be moved as quickly as possible to each separate rack compartment or container stored there so that the cause of a fire or a potential fire source can be dealt with as quickly as possible. Due to the preferred separate rack compartments, it is possible access and remove items from each individual container with influencing other containers within the high-bay storage systems. In particular, there is no need to stack containers that have not yet been affected all the way up to the affected container on top.

It is particularly preferred if a stacker crane connected to a fire extinguishing device removes a container at risk of fire or one that is already overheated from the respective rack compartment and preferably immediately begins to fight the fire or at least to contain the temperature or the temperature rise by means of the fire extinguishing device. This can preferably take place when the corresponding container is being retrieved from the rack compartment and during the transport thereof to a safe fire-fighting location outside or inside the high-bay storage system. This provides a system that, on the one hand, enables fire to be fought as quickly as possible and, on the other hand, ensures that the area surrounding the container at risk of fire or area of the high-bay storage system is made safe as quickly as possible.

It is preferred in this connection if the fire extinguishing device has a reservoir for extinguishing agent, preferably a reservoir that can be placed at the top of the stacker crane and in particular is interchangeably connected to the stacker crane, as well as an apparatus for supplying the extinguishing agent to the interior of a container. This provides a system that enables fire to be fought substantially autonomously and can preferably provide a sufficient amount of suitable extinguishing agent in situ and deliver it to the interior the container. Suitable extinguishing agents can be foam, water, CO2 or the like, which are able to reduce the temperature inside the container, to displace the oxygen needed to maintain a fire and, generally speaking, restrict chemical reactions, including of different contents within a container, to the unavoidable minimum. A reservoir that can be placed at the top of the stacker crane enables extinguishing agents to be introduced into the interior of the container substantially under the influence of gravity, so that pump systems with less power can be used.

The apparatus for supplying the extinguishing agent to the interior of a container can preferably be a piercer, which is able to pierce the outer skin of a container. Such piercers are already widely used for extinguishing vehicle fires, and when the piercer is placed on the outer skin, not only does it enable the piercing of the outer skin, but also the simultaneous introduction of extinguishing agent into the interior, for example through extinguishing agent supply openings integrated within the piercer. It is particularly preferred if the piercer remains on the outer skin of the container throughout the entire extinguishing process, so as to prevent ambient air and oxygen from flowing into the interior of the container, at least during the extinguishing process itself.

It is preferred if the fire extinguishing device can be activated from the outside. This creates a system that enables fully automatic operation of the fire extinguishing device but still separates the removal of a container from a rack compartment from the introduction of extinguishing agents into the interior of the container, and preferably lets the operator choose which function the fire extinguishing device is, and in some cases is not, to perform in each individual case. This creates a system that allows for maximum flexibility and a response tailored to each fire event or potential hazard. For example, in the case of a change in temperature or absolute temperature that is deemed dangerous, it may be considered entirely appropriate to remove a container from its rack compartment but to not introduce any extinguishing agents into the interior of the container, which risks damaging or destroying the goods stored therein. It might also make sense to leave a container in place in its rack compartment so as, for example, to locally limit the further spread of liquids that are already burning, but to also supply extinguishing agent to the interior of the container. All of this can preferably be determined and activated from the outside, without the risk of an unavoidable automatic effect that could cause the greatest possible damage to the high-bay storage system as a whole or to individual containers or goods stored within the high-bay storage system.

A device for detecting the temperature and/or a change in temperature of a plurality of rack compartments, preferably of more than 30% of the rack compartments, with preference of more than 50% of the rack compartments, particularly preferably of more than 90% of the rack compartments, with particular preference of all of the rack compartments, can be provided within the high-bay storage system. This guarantees that unexpected or undesired temperature changes in separate areas of the high-bay storage systems are noticed and preferably indicated as early as possible, so that suitable steps can then be undertaken, either automatically or manually, to keep the harmful effects on the surrounding area to the absolute minimum, or prevent them entirely.

Such countermeasures can preferably include removing a burning container, or one at risk from fire, from the rack compartment and particularly preferably moving it to a location that no longer poses a risk of damage to the surrounding area and in particular to the structural integrity of the high-bay storage system. Such locations can be, for example, extinguishing places provided within the high-bay storage system or preferably locations outside the high-bay storage system. If a fire or hazard is detected early, the containers at risk of fire or overheating can be moved by means of the stacker cranes that are already provided in the high-bay storage system for transporting the containers.

It is preferred if the device for detecting the temperatures and/or a change in temperature of rack compartments is connected to a display and/or evaluation unit. This display and/or evaluation unit is preferably configured and designed such that the signals from a fibre optic cable or each sensor of the device for detecting the temperature and/or a change in temperature can be evaluated separately. This provides a system that is preferably able to separately record and evaluate the temperature and/or change in temperature of each individual rack compartment or each individual container stored therein, at least from the immediate surroundings of said container. This also makes it possible to determine the origin of the container fire within the high-bay storage system.

It is particularly preferred in this connection if the display and/or evaluation unit can establish that a previously defined threshold value for the temperature and/or for a change in temperature per unit of time within a rack compartment has been exceeded, or that the temperature surrounding a stored container has been exceeded, and then preferably output a visual and/or audible warning signal. This provides a system that preferably fully automatically and at the earliest possible time determines an incident or potential incident and immediately outputs it to the operator of the high-bay storage system, so that suitable countermeasures can be initiated as soon as possible. This increases safety during operation of the high-bay storage system using means that are easy to manage.

The device for detecting the temperature and/or a temperature change preferably comprises optical and/or electrical sensors. Optical sensors can include, for example, infrared cameras which are able to optically record relatively large areas of high-bay storage systems and yet monitor temperature rises or the absolute temperature of each individual rack compartment or container. However, fibre optic cables are preferred. Likewise preferred are electrical sensors, which are preferably assigned to each monitored rack compartment. Such electrical sensors can easily be integrated into the existing structure of a high-bay storage system without impeding the transport or the storage of the containers using the stacker cranes or without containers and/or stacker cranes at least temporarily shielding the individual sensors.

It is particularly preferred in this connection if the device for detecting the temperature and/or a change in temperature comprises at least one cable in which sensors are embedded at a specified distance from one another. Particular preference is given to a cable in which the sensors are installed at equal distances of preferably between 1 and 2 m from one another, wherein the at least one cable is preferably provided at an equal distance from a row of rack compartments in the high-bay storage system. It is particularly preferred if the one cable is interchangeably connected to the high-bay storage system. This creates a system that enables large areas of the high-bay storage system, or preferably the entire high-bay storage system, to be reliably monitored with means that are particularly easy to manage. This is preferably effected using commercially available sensor cables which are known as linear heat detectors and comprise a plurality of sensors that can all be connected to a sensor control unit (SCU).

These sensor cables measure the temperature by means of electronic sensors that are preferably fully embedded in the sensor cable. The measurement range is preferably between −40° C. and +85° C., with a temperature resolution of 0.1° C. or better.

It is preferred if the cable, either the sensor cable or the fibre optic cable, has a heat-resistant sheathing, in particular a sheathing with thermal storage properties. This provides a device for detecting the temperature and/or a change in temperature that is not only suitable for precisely recording and indicating the location at which the temperature and/or change in temperature is measured, but also for increasing the reliability and resolution accuracy of the detection.

It is preferred if the storage spaces or separate rack compartments are designed and suitable for receiving a 20′ standard container (1 TEU, twenty-foot equivalent unit) or a 40′ standard container (2 TEU) or else for receiving two standard containers of half length arranged one behind the other in their longitudinal direction. Thus two 20′ standard containers that are end-to-end at their front sides can be stored in a storage location or separate rack compartment which is designed for receiving a 40′ standard container, or two 10′ standard containers (0.5 TEU) can also be stored in a storage location or separate rack compartment which is designed for receiving a 20′ standard container. This results in a high-bay storage system which allows the containers to be handled in a fully automated manner while making optimum use of the space.

It is preferred in this connection in particular if the stacker crane can move the containers into and out of the storage spaces, preferably rack compartments, with the longitudinal sides of said containers aligned parallel to the storage aisles. This firstly leads to the arrangement-described above as being preferred-of two rows of storage spaces, preferably rack compartments, on each side of a stacker crane being supported particularly advantageously. On the other hand, this also leads to a minimal width of the storage aisles needed for the stacker cranes.

It is particularly preferred in this connection if the high-bay storage system is designed such that it can store more than 2500 standard containers per ha, (2500 TEU/ha), preferably more than 3000 TEU/ha. The unit shown here, TEU per ha, represents a measure used in the industry for the storage capacity of port logistics and in particular of high-bay storage systems.

In accordance with a further aspect, a method is provided for fighting and preferably detecting container fires in such a high-bay storage system in accordance with the above-described first aspect. Within this high-bay storage system, the containers are picked up by means of the stacker cranes, transported to the respective rack compartments and stored therein.

### BRIEF DESCRIPTION OF THE DRAWINGS

The invention is explained in more detail hereinbelow with reference to two figures, which show preferred embodiments. The figures are not intended to limit the scope of protection the invention.

FIG. 1 shows a schematic view of a high-bay storage system 1;

FIG. 2 shows an overall view and an enlarged partial view of a stacker crane which is used in a high-bay storage system 1 and in a method for detecting and preferably fighting fires in a high-bay storage system and which has an integrated fire extinguishing device.

### DETAILED DESCRIPTION

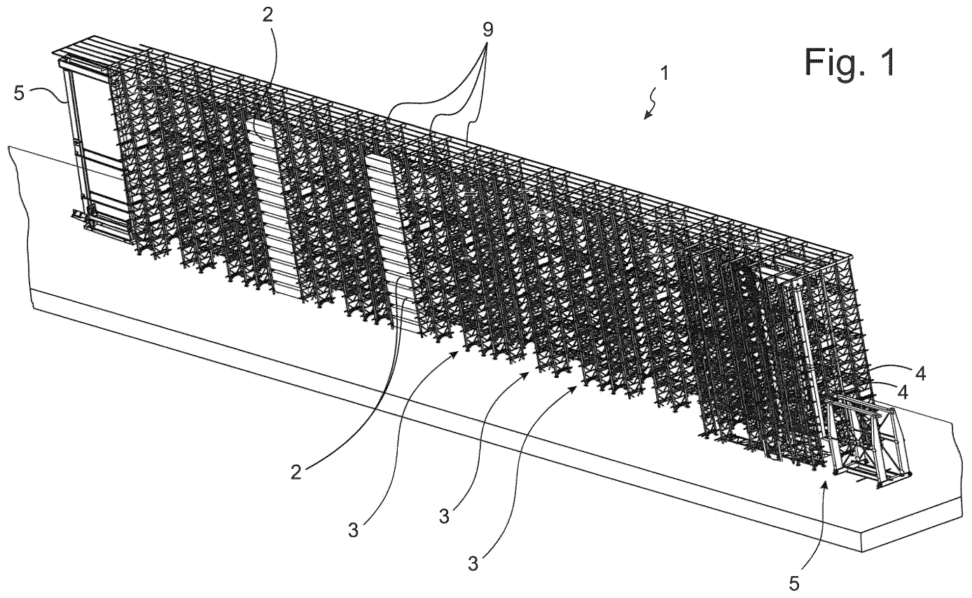

FIG. 1 shows a high-bay storage system 1 with a plurality of rack compartments 3 arranged one above another and next to one another in which containers 2 can be stored separately. The loading and unloading of the separate rack compartments 3 with containers 2 is done using stacker cranes 5, which are arranged so as to be able to move in the respective storage aisles 4 of the high-bay storage system 1 over the length thereof. The stacker cranes 5 can pick up containers 2, for example from an external position or a transfer position arranged below their travel plane, and then transport them within the respective storage aisle 4 and over the entire height of the high-bay storage system 1. The rack compartments 3 are then loaded by means of telescopic systems (not shown) that are connected to the stacker cranes 5 move containers 2 over the longitudinal sides of the container 2 on both sides of the respective storage aisle 4 into the separate rack compartments 3. In the same way, the containers 2 are also unloaded from the rack compartments 3 and moved either to another rack compartment 3, to a fire-fighting location arranged within the high-bay storage system 1 and not shown here, or entirely out of the high-bay storage system 1, in order to carry out the fire-fighting here or a controlled burning without having to worry about influencing other containers 2 or the structure of the high-bay storage system 1. Cables 9 are provided running along above each row of rack compartments 3 within the high-bay storage system 1, with only a few cables 9 being shown in the illustration. The cables 9 have a plurality of sensors (not shown) embedded therein, with at least one sensor (not shown) being provided per rack compartment 3. Preferably, at least one to two, preferably two, sensors are used per rack compartment 3. The cables 9 extend at equal distances along the length of the container 2, preferably along the structure of each rack compartment 3, and are therefore connected to a display or evaluation unit (not shown) such that each rack compartment 3 and each container 2 stored therein are monitored and the rise in the temperature in each rack compartment 3 can be detected and displayed separately.

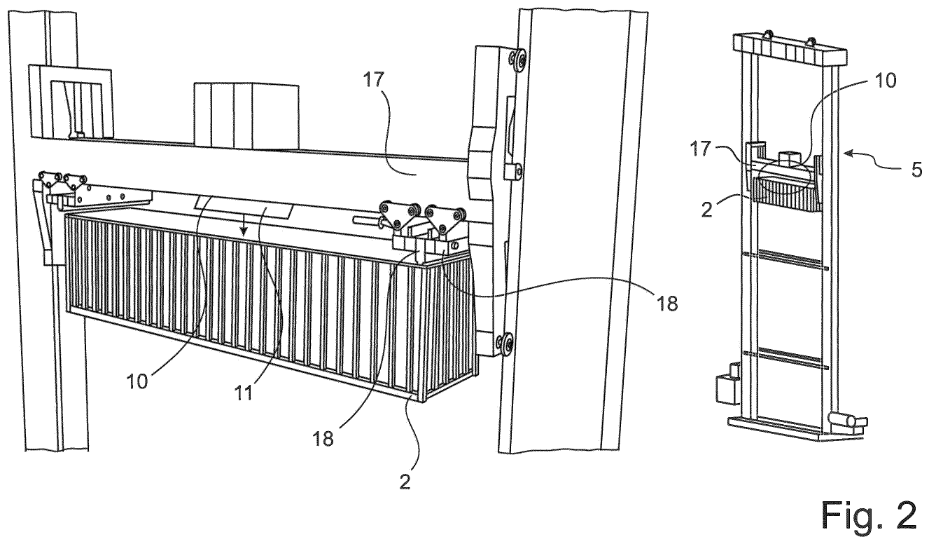

FIG. 2 shows on the right-hand side an overall view of a stacker crane 5 for use in a high-bay storage system (not shown here). The stacker crane 5 is designed to be so narrow that it can travel over the entire length of the narrow storage aisles (not shown) of a high-bay storage system (not shown) and, at the same time as or independently of this longitudinal movement, can move containers 2 suspended over the entire height of the high-bay storage systems (not shown). The containers 2 are stored in and retrieved from the rack compartments (not shown) via telescopic systems 18 connected to the crossbeam 17, by means of which the containers 2 can be moved outwards, suspended on both sides of the stacker crane 5, and into or out of the rack compartments (not shown). A fire extinguishing device 10 with a reservoir 11 for extinguishing agent is arranged on the crossbeam 17. If an excessive temperature rise or the exceedance of a previously defined maximum temperature is detected, the fire extinguishing device 10 enters into operative connection with the container 2, in which case a flap 19 arranged on the underside of the fire extinguishing device 10 is opened and allows the passage of a piercer (not shown) from the fire extinguishing device 10 onto the container 2. By means of suitable setting equipment, the piercer (not shown) is placed from above onto the container 2, pierces the outer skin of the container and then conveys extinguishing agent from the reservoir 11 via a supply line (not shown) through supply openings arranged within the piercer (not shown) and into the interior of the container 2. This provides a system and a method by means of which not only can a container at risk of fire, or one that is already burning, be separated from the high-bay storage system (not shown) as quickly as possible, but also fire-fighting and/or cooling of the interior of the container 2 can take place as early as possible.

### LIST OF REFERENCE DESIGNATIONS

1 high-bay storage system
2 container
3 separate rack compartment
4 storage aisle
5 stacker crane
9 cable
10 fire extinguishing device
11 reservoir
17 crossbeam
18 telescopic system
19 flap

1-20. (canceled)

21. A high-bay storage system (1) for storing and retrieving containers (2), comprising:
a plurality of rack compartments (3) for the containers (2), the rack compartments (3) being arranged horizontally next to one another and vertically one above another;
storage aisles (4) arranged between groups of the rack compartments (3), the storage aisles (4) extending parallel to one another; and
a respective stacker crane (5) arranged in each of the storage aisles (4), wherein the respective stacker crane (5) is movable back and forth and configured to move the containers (2) vertically and horizontally and into and out of the rack compartments (3),
wherein at least one respective stacker crane (5) is connected to a fire extinguishing device (10).

22. The high-bay storage system (1) according to claim 21,
wherein the fire extinguishing device (10) has
a reservoir (11) for an extinguishing agent placed at a top of the respective stacker crane (5) and interchangeably connected to the respective stacker crane (5), and
an apparatus for supplying the extinguishing agent to an interior of one of the containers (2).

23. The high-bay storage system (1) according to claim 22,
wherein the apparatus for supplying the extinguishing agent to the interior of the one of the containers (2) has a piercer for piercing an outer skin of the one of the containers (2).

24. The high-bay storage system (1) according to claim 21,
wherein the fire extinguishing device (10) can be activated from outside.

25. The high-bay storage system (1) according to claim 21,
further comprising a device (7) for detecting a temperature and/or a change in temperature of the rack compartments (3).

26. The high-bay storage system (1) according to claim 25,
wherein the device (7) for detecting the temperature and/or the change in temperature of the rack compartments (3) is connected to a display and/or evaluation unit (8) configured to evaluate signals from sensors (6) of the device (7) for detecting the temperature and/or the change in temperature.

27. The high-bay storage system (1) according to claim 26,
wherein the display and/or evaluation unit (8) outputs an exceedance of a predefined threshold value for the temperature and/or for the change in temperature within one of the rack compartments (3) or an exceedance of an external temperature of one of the containers (2) and outputs a visual and/or audible warning signal.

28. The high-bay storage system (1) according to claim 25,
wherein the device (7) for detecting the temperature and/or the change in temperature is configured and designed to record a temperature surrounding at least one of the containers (2) stored in one of the rack compartments (3).

29. The high-bay storage system (1) according to claim 25,
wherein the device (7) for detecting the temperature and/or the change in temperature comprises optical and/or electrical sensors (6).

30. The high-bay storage system (1) according to claim 25,
wherein the device (7) for detecting the temperature and/or the change in temperature comprises a cable (9),
wherein sensors (6) are embedded at equal distances of between 1 and 2 m from one another in the cable (9), and
wherein the cable (9) is provided at a distance from a row of rack compartments (3) in the high-bay storage system (1), and interchangeably connected to the high-bay storage system (1).

31. The high-bay storage system (1) according to claim 30,
wherein the cable (9) has a heat-resistant sheathing (9a).

32. The high-bay storage system (1) according to claim 25,
wherein the device (7) for detecting the temperature and/or the change in temperature is able to determine an origin of a container fire.

33. The high-bay storage system (1) according to claim 21,
wherein the rack compartments (3) are designed and suitable for receiving a 20-foot standard container (1 TEU) or a 40-foot standard container (2 TEU), or two standard containers of half length arranged one behind another in a longitudinal direction.

34. The high-bay storage system (1) according to claim 21,
wherein the respective stacker crane (5) can move the containers (2) into and out of the rack compartments (3) with longitudinal sides of the containers being aligned parallel to the storage aisles (4).

35. The high-bay storage system (1) according to claim 21,
wherein the respective stacker crane (5) can transport the containers (2) suspended and supported from above.

36. The high-bay storage system (1) according to claim 21,
wherein the high-bay storage system (1) is suitable for storing more than 2500 TEU/ha.

37. A method for detecting and fighting fires in a high-bay storage system (1), comprising:
storing a container within a rack compartment (3) of the high-bay storage system (1);
monitoring a temperature and/or change in temperature of the container (2) or an area surrounding the container; and
removing the container (2) from the rack compartment (3) by a stacker crane (5) in case a predefined threshold value of the temperature and/or a change in temperature is exceeded.

38. The method according to claim 37, further comprising
conveying the container (2) removed from the high-bay storage system (1) by the stacker crane (5) to a container storing bay within the high-bay storage system (1).

39. The method according to claim 37, further comprising
introducing an extinguishing agent into an interior of the container (2) by a fire extinguishing device (10) connected to the stacker crane (5) while or after the container (2) is being picked up by the stacker crane (5).

40. The method according to claim 39,
wherein the extinguishing agent is introduced by an activatable piercer.
